(19) United States
(12) Patent Application Publication
(10) Pub. No.: US 2025/0389835 A1
(43) Pub. Date: Dec. 25, 2025

(54) METHOD FOR DETERMINING A POSE OF ANOTHER ROAD USER

(71) Applicant: Robert Bosch GmbH, Stuttgart (DE)

(72) Inventors: Guillaume JORNOD, Bern (CH); Keno GARLICHS, Braunschweig (DE); Maximilian STARK, Hamburg (DE); Nico OSTENDORF, Hannover (DE); Tobias FRYE, Braunschweig (DE)

(21) Appl. No.: 19/224,955

(22) Filed: Jun. 2, 2025

(30) Foreign Application Priority Data
Jun. 19, 2024 (DE) 10 2024 205 640.5

(51) Int. Cl. G01S 13/02; G01S 13/89; G01S 13/931; G08G 1/16; H04W 4/46

(52) U.S. Cl. CPC G01S 13/0209; G01S 13/89; G01S 13/931; G08G 1/161; H04W 4/46

(57) ABSTRACT

A method for determining a pose of another road user. The method includes the following steps performed by a road user using a multi antenna ultra-wideband system: receiving information including an indication regarding a capability for ultra-wideband-based ranging of the other road user, at least one set of parameters for two or more ultra-wideband units to configure a respective ultra-wideband unit, and information with respect to a geometric relationship of two or more ultra-wideband units of the other road user; configuring the ultra-wideband units of the road user based on the set of parameters to enable a respective ultra-wideband ranging measurement; performing the respective ultra-wideband ranging measurement between the ultra-wideband units of the two road users; determining a pose of the other road user based on each or a subset of the performed ultra-wideband ranging measurements and based on the geometric relationship of the other road user's ultra-wideband units.

### CROSS REFERENCE

The present application claims the benefit under 35 U.S.C. § 119 of German Patent Application No. DE 10 2024 205 640.5 filed on Jun. 19, 2024, which is expressly incorporated herein by reference in its entirety.

### FIELD

The present invention relates to a method for determining a pose of another road user. Furthermore, the present invention relates to a computer program and a storage medium for this purpose.

### BACKGROUND INFORMATION

Positioning can be a challenging topic with respect to road safety. Currently, positioning is mainly based on information from Global Navigation Satellite Systems (GNSS). The position information is exchanged via Vehicle to X (V2X) technology to inform other road participants. However, GNSS is often not accurate enough to solve risky traffic situations. Another technology for positioning is provided by infrastructure. Cameras with fixed locations map the different road participants and inform them about the current positions of all seen participants. The disadvantage of this technology is that in rural or suburban areas such an infrastructure is not available.

From a vehicle perspective, different sensor types are available to detect and localize other road users for avoiding critical traffic situations. However, those sensors are often limited to a line of sight (LOS) to detect or localize a target object.

### SUMMARY

According to aspects of the present invention, a method, a computer program, and a computer-readable storage medium are provided. Features and details of the present invention are disclosed herein. Features and details described in the context to the method of the present invention also correspond to the computer program of the present invention and vice versa in each case.

According to an aspect of the present invention, a method for determining a pose of another road user is provided. According to an example embodiment of the present invention, the method comprises the following steps performed by, preferably a computer of, a road user, in particular a vehicle and/or a vulnerable road user, using a multi antenna ultra-wideband system:
Receiving information comprising an indication regarding a capability for ultra-wideband-based ranging of the other road user, at least one set of parameters for two or more ultra-wideband units of the road user to configure a respective ultra-wideband unit, and an information with respect to a geometric relationship of two or more ultra-wideband units of the other road user,
Configuring the two or more ultra-wideband units of the road user based on the at least one set of parameters to enable a respective ultra-wideband ranging measurement,
Performing the respective ultra-wideband ranging measurement between the two or more ultra-wideband units of the two road users,
Determining a pose of the other road user based on each or a subset of the performed ultra-wideband ranging measurements and based on the geometric relationship of the other road user's ultra-wideband units, wherein the pose comprises a position information and/or an orientation information of the other road user.

This allows for accurate positioning, which can be achieved through receiving and configuring messages from the other road users' ultra-wideband units, performing ranging measurements between these units, and determining the pose based on the measurements and geometric relationships. Further, this advantageously improves the accuracy compared to traditional GNSS-based systems significantly and increases an availability in areas where satellite signals may not be available.

Furthermore, the method and system of the present invention can provide both position information and orientation information, allowing for a more comprehensive understanding of the other road user's pose.

The multi-antenna ultra-wideband system enables multiple ranging measurements between different road users' units, which can be used to determine their relative positions and orientations. This allows for accurate positioning and tracking of other road users, even in areas where satellite signals may not be available or are compromised by obstacles or multipath effects. The system's ability to provide both position information and orientation information enables more precise pose determination, which can be critical for advanced driver-assistance systems (ADAS) and autonomous vehicles.

UWB, or Ultra-Wideband, is a radio technology that uses an extremely low energy level for short-range, high-bandwidth communications over a large portion of the radio spectrum. UWB capability refers to the ability of devices to perform functions that require large bandwidth and precise positioning with minimal interference. UWB technology can be particularly noted for its ability to accurately determine the position of objects, devices, or road users within centimetres. This allows to use this technology for real-time location systems, such as in traffic situation or scenarios, in industrial automation, smart homes, or healthcare environments. UWB may operate with exceptionally low power, making it ideal for use in battery-operated devices like mobile phones and wearables. The wide bandwidth and unique signal characteristics of UWB make it difficult to intercept, providing an additional layer of security for data transmission.

Due to its large bandwidth and the nature of its signal, UWB is less likely to interfere with other radio bands, which is advantageous in the crowded spectrum.

Devices with UWB capability can leverage these characteristics for applications such as close proximity data transfer, precise location tracking within complex environments, and secure communication channels for connected devices.

An ultra-wideband unit or a UWB tag is a device that uses ultra-wideband (UWB) technology to precisely locate and track objects or people it is attached to. These tags emit short pulses over a wide frequency spectrum, which makes it possible to determine their exact position indoors or in other environments with high accuracy. UWB tags can be used, for example, to track inventory in warehouses, for security monitoring in factories or to locate people in emergency situations. They are a key component in various applications that rely on precise location and tracking.

The “pose” of a road user refers to the position and orientation of a person or vehicle in the context of traffic and road safety. This term can be used in discussions about autonomous vehicles, traffic management systems, and safety analysis to describe how road users are situated or moving within a traffic scene. For humans (like pedestrians or cyclists), it includes body posture and movements. For vehicles, it involves the direction and alignment relative to road lanes, other vehicles, and traffic controls. Understanding the pose helps in predicting behaviour, assessing risk, and improving safety measures on roads.

According to an example embodiment of the present invention, it is possible that the information comprises a different set of parameters for each ultra-wideband unit of the road user, or one single set of parameters for all ultra-wideband units of the road user, to configure the respective ultra-wideband unit.

It is further possible that the information is received via a message from the other road user, wherein the message comprises one preamble in case of one single set of parameters, or wherein the message comprises at least two preambles in case of different sets of parameters.

This feature allows for multiple ultra-wideband units to be configured with identical or different sets of parameters, enabling unique identification and synchronization of each unit. The ability to assign distinct ultra-wideband parameter settings to individual ultra-wideband units has the advantage that interference can be reduced and improves the signal integrity. Further, this allows to Increase a flexibility in system design, as the same ultra-wideband technology can be used for multiple applications with different configuration requirements.

Furthermore, this feature allows for a single ultra-wideband tag to operate independently, with its own set of parameters, without affecting the operation of other tags in the system. In scenarios where multiple ultra-wideband units are used by different road users or vehicles, this feature enables accurate identification and tracking of each unit, even in environments with high levels of interference.

According to an example embodiment of the present invention, it is possible that the message is a V2X-message or a corporative awareness message or a vehicle awareness message.

According to an example embodiment of the present invention, it is possible to enhance the functionality of the multi-antenna system by utilizing the received messages, including V2X-messages and/or awareness messages. This enables the system to leverage existing communication protocols and infrastructure, thereby expanding its capabilities. The inclusion of V2X-messages allows for seamless integration with existing vehicle-to-everything (V2X) technologies, enabling the sharing of safety-critical information between vehicles, infrastructure, and pedestrians. Further, this enhances road safety by providing earlier warnings of potential hazards, such as accidents or road closures.

Awareness messages can be used to disseminate general traffic information, such as congestion levels, roadwork schedules, or special events, thereby helping drivers make more informed decisions about their routes and travel times. This feature also enables the system to provide contextualized information to drivers, considering their specific location and circumstances.

By incorporating these types of messages, the multi-antenna system can become a valuable component of a larger intelligent transportation system (ITS), providing real-time data and insights that benefit both individual drivers and the overall traffic infrastructure.

According to an example embodiment of the present invention, it is also possible that the geometric relationship is specified by a respective position of the two or more ultra-wideband units in relation to each other or to a common reference point.

This allows to enhance accuracy and robustness of position estimation significantly.

By specifying the geometric relationship between ultra-wideband units, the system can consider several factors that affect positioning accuracy, such as the relative distance and orientation of the units with respect to each other and the environment. This enables the system to better correct for errors caused by multipath effects, non-line-of-sight propagation, and other sources of inaccuracy. Furthermore, specifying the geometric relationship can also facilitate more efficient data processing and transmission between ultra-wideband units. For instance, the system can use this information to reduce the amount of data required to be transmitted or to improve the signal quality by adjusting the transmission power and beamforming.

According to an example embodiment of the present invention, it is possible that during the performing of the respective ultra-wideband ranging the method comprises the further following step:
Initiating the respective ranging measurement between two or more ultra-wideband units of the road user and/or the other road user using a Time Difference of Arrival measurement and/or Angle of Arrival measurement, wherein the ranging measurement is used to determine the relative distance and direction between the two road users.

Here, the respective ranging measurement may be initiated between at least one ultra-wideband unit of the road user and at least one ultra-wideband unit of the other road user. These measurement types allow for more precise determination of relative distance and direction between road users, enhancing overall system performance. Further, this feature can facilitate better multi-path mitigation and interference reduction in various environments, such as urban and rural settings. Furthermore, the use of TDoA and AoA measurements can improve the robustness of the system by providing a redundant measurement channel for situations where direct line-of-sight signals are compromised or unavailable.

According to an example embodiment of the present invention, it is also possible that the method comprises the further following step:
Mapping a result of the respective ranging measurement from each or the subset of the two or more ultra-wideband units to a local coordinate system of the road user, allowing for the determination of the absolute position of the other road user.

This feature allows for accurate calculation of the position of another road user, considering the relative positions of the multiple ultra-wideband tags communicating with each other. Further, this has the advantage that the ability to accurately determine the position of another road user in real-time allows for more precise tracking and monitoring of road participants. Furthermore, an enhanced situational awareness, as the absolute position of other road users can be determined, allows to improve a decision-making for autonomous vehicles or other applications.

According to an example embodiment of the present invention, it is further possible that each or the subset of the respective ultra-wideband ranging measurements between two or more ultra-wideband units of the road user and/or the other road user is performed sequentially or in parallel. Here, the ranging measurement may be performed between at least one ultra-wideband unit of the road user and at least one ultra-wideband unit of the other road user.

Sequential measurement advantageously enables a more accurate positioning by processing individual measurements before proceeding to the next one, allowing for correction of any errors that may have occurred during the previous measurement. This approach further allows for easier integration with existing systems that rely on sequential data processing. Parallel measurement, on the other hand, advantageously enables a simultaneous measurement taking, which can significantly reduce the overall positioning time and increase the system's responsiveness to changing environmental conditions. This is particularly beneficial in high-speed applications where real-time accuracy is crucial.

The use of parallel measurement further advantageously provides opportunities for advanced algorithms that can combine data from multiple measurements to improve positioning accuracy and robustness against interference or other errors. Furthermore, the parallel processing architecture can be designed to accommodate a wide range of ultra-wideband unit configurations, allowing for flexibility in system deployment and scalability to support large-scale applications. Further, this feature enables the implementation of more advanced positioning algorithms that consider the characteristics of the ultra-wideband signals, such as frequency and phase offsets. These algorithms can further enhance the accuracy and reliability of the positioning system by accounting for these signal characteristics.

According to an example embodiment of the present invention, it is also possible that the steps of the method are performed iteratively in a tracking process between two road users in order to refine the determination of the pose.

According to an example embodiment of the present invention, it is possible to implement iterative processing to refine positioning estimates in real-time. This feature has the advantage that multiple iterations of positioning calculations between two road users are performed, allowing for continuous refinement and improvement of the accuracy of the estimated position. A further advantage is enhanced precision, as repeated calculations can further eliminate errors and provide a more accurate representation of the actual distance or proximity between the two road users. Furthermore, iterative processing allows for adaptive adjustments to be made in response to changing environmental conditions, such as movement or interference from other objects or signals.

Furthermore, this feature enables real-time tracking and monitoring of the relative positions between road users, enabling applications such as collision avoidance, traffic management, and autonomous vehicle navigation. By continuously refining positioning estimates, the system can respond rapidly to changes in the environment, providing a more reliable and effective solution for various use cases.

According to an example embodiment of the present invention, it is possible that the method comprises the further following step:
Providing information regarding the relative position of the other road user to one or more driver assistance systems of the road user to enable improved safety features.

This feature allows for more accurate and timely reaction to the presence or trajectory of nearby vehicles, pedestrians, or other road users, thereby reducing the risk of accidents. Further, the integration of this information with existing safety features can lead to improved performance in areas such as automatic emergency braking, lane departure warning, and collision detection. Furthermore, this feature can also facilitate more effective coordination between different vehicles and infrastructure elements, enabling advanced traffic management and optimization strategies.

In another aspect of the present invention, a computer program may be provided, in particular a computer program product, comprising instructions which, when the computer program is executed by a computer, cause the computer to carry out the method according to the present invention. Thus, the computer program according to the present invention can have the same advantages as have been described in detail with reference to a method according to the present invention.

In another aspect of the present invention, an apparatus for data processing may be provided, which is configured to execute the method according to the present invention. As the apparatus, for example, a computer can be provided which executes the computer program according to the present invention. The computer may include at least one processor that can be used to execute the computer program. Also, a non-volatile data memory may be provided in which the computer program may be stored and from which the computer program may be read by the processor for being carried out.

According to another aspect of the present invention a computer-readable storage medium may be provided which comprises the computer program according to the present invention and/or instructions which, when executed by a computer, cause the computer to carry out the steps of the method according to the present invention. The storage medium may be formed as a data storage device such as a hard disk and/or a non-volatile memory and/or a memory card and/or a solid state drive. The storage medium may, for example, be integrated into the computer.

Furthermore, the method according to the present invention may be implemented as a computer-implemented method. Alternatively, or additionally, at least one of the disclosed method steps may be computer-implemented and/or automated.

Further advantages, features and details of the present invention will be apparent from the following description, in which embodiments of the present invention are described in detail with reference to the figures. In this context, the features disclosed herein may each be essential to the present invention individually or in any combination.

### BRIEF DESCRIPTION OF THE DRAWINGS

FIG. 1 shows a method, computer program, a storage medium and apparatus according to example embodiments of the present invention.

FIG. 2 shows a schematic diagram according to example embodiments of the present invention.

FIG. 3 shows a further schematic diagram according to example embodiments of the present invention.

FIG. 4 shows a schematic flow diagram according to example embodiments of the present invention.

FIG. 5 shows another schematic flow diagram according to example embodiments of the present invention.

FIG. 6 shows an exemplary layout of UWB technology according to example embodiments of the present invention.

In the following figures, the identical reference signs are used for the same technical features even of different embodiment examples.

### DETAILED DESCRIPTION OF EXAMPLE EMBODIMENTS

According to the present invention, a multi-antenna system based on UWB technology is used to provide perfectly accurate positionings. The system uses multiple ultra-wideband tags to communicate with each other and determine the relative position between different road users. This allows for more accurate positioning compared to GNSS and availability of UWB does not depend on location. Multiple UWB units or tags can be used on board of each road user with a mapping between the different sensors and a schema in which the specific sensors perform ranging. A usage of one or multiple different sets of parameters (frequency, symbol duration, and security key) for all UWB units can be provided for each road user. Further, using V2X technology to trigger an UWB ranging measurement between two road participants can be provided.

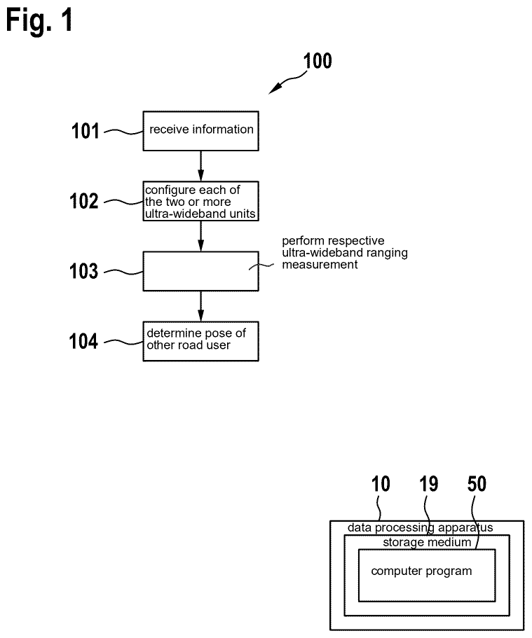

FIG. 1 depicts a method 100, a computer program 50, a computer-readable storage medium 19 and a data processing apparatus 10 or device according to embodiments of the present invention.

FIG. 1 particularly shows an embodiment of a method 100 for determining a pose of another road user 20, in particular a bicycle 20. The method 100 comprises the following steps performed by a road user 10, in particular a vehicle 10, using a multi antenna ultra-wideband system:

In a first step 101 an information is received comprising an indication regarding a capability for ultra-wideband-based ranging of the other road user 20, at least one set of parameters for two or more ultra-wideband units (11, 12) to configure a respective ultra-wideband unit (11, 12) and an information with respect to a geometric relationship of two or more ultra-wideband units 21, 22 of the other road user 20. In a next step 102 each of the two or more ultra-wideband units 11, 12 of the road user 10 is configured based on the at least one set of parameters to enable a respective ultra-wideband ranging measurement. At step 103 the respective ultra-wideband ranging measurement is performed between each of the two or more ultra-wideband units 11, 12, 21, 22 of the two road users 10, 20. In a step 104 a pose of the other road user 20 is determined based on each or a subset of the performed ultra-wideband ranging measurements and based on the geometric relationship of the other road users ultra-wideband units 21, 22. The pose comprises a position information and/or an orientation information of the other road user 20.

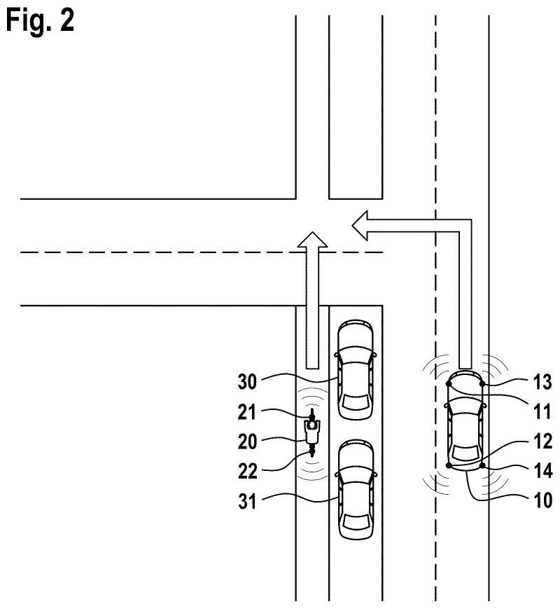

FIG. 2 shows a schematic diagram according to embodiments of the present invention. In particular, FIG. 2 depicts an exemplary use case regarding two road users 10, 20 in a certain traffic scenario. In this scenario one road user 10 such as a vehicle or a car wants to turn left on a road, but there is another road user 20 such as a bicycle driving in the same direction as the vehicle 10 behind some parking vehicles (30, 31). Therefore, the parking cars 30, 31 block the view to the bicycle 20 for the road user 10 or vehicle 10.

By using a ultra-wideband multi antenna system for each road user 10, 20 it is possible for the vehicle 10 to locate the bicycle 20 relative to its own ego position, because the ultra-wideband (UWB) units 11, 12 or UWB tags 11, 12 on one side of the vehicle 10 detect a lower relative distance to the other road user 20 or bicycle 20 as the units 13, 14 on the other side of the vehicle 10. Further, the front 11 and the rear left tag 12 of the vehicle 10 detect a very similar distance, which indicates that the other road user 20 or bicycle 20 is driving in parallel to the vehicle 10. The bicycle 20 or in case of anther vehicle 20 as the other road user 20 both could determine the position of the vehicle 10 in the same way.

In another embodiment (not shown), it is also sufficient if one 10 of the two road users 10, 20 detects the dangerous traffic situation and informs the other road user 20, for example, by sending a V2X awareness message such as a CAM- or VAM-message.

In a further embodiment, for example, one road user 10 may send an explicit immanent collision risk warning in form of a DENM-message.

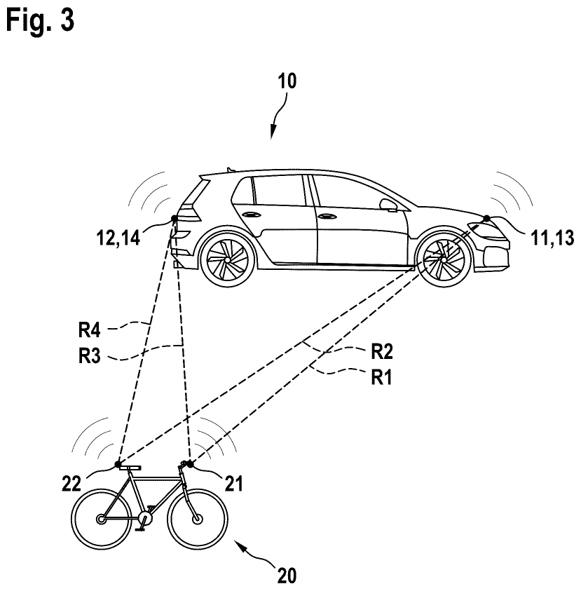

FIG. 3 depicts a schematic diagram according to embodiments of the present invention, particularly, FIG. 3 illustrates a vehicle or a car as one road user 10 and a bicycle as the other road user 20. Each road user 10, 20 comprises two or more ultra-wideband units or UWB tags. The vehicle 10 comprises can comprise for example two UWB tags 11, 12 as depicted in FIG. 3 or four UWB tags 11, 12, 13, 14 as shown in FIG. 2. The bicycle can comprise two UWB tags 21, 22 as shown in FIG. 2 and FIG. 3. Further, in FIG. 3 the ranging measurements R1, R2, R3, R4 between each of the UWB units 11, 12, 13, 14, 21, 22 are illustrated.

Road users 10, 20 such as vehicles and/or vulnerable road users should be equipped with multiple ultra-wideband units 11, 12, 13, 14, 21, 22 or tags 11, 12, 13, 14, 21, 22 to communicate with each other or to perform ranging measurements between them. These UWB units are used to locate a nearby (other) road user or other road participant relative to the own ego position. The determined position or location of the other road user could be used in traffic scenarios or use cases such as for example turning, parking, overtaking and for supporting driver assistance systems.

According to embodiments of present invention as shown in FIG. 1 to FIG. 5 an ultra-wideband multi-antenna system is comprised for each road user 10, 20. Thus, multiple anchors 11, 12, 13, 14, 21, 22—meaning UWB units or tags—are placed on the two road users 10, 20 such as the vehicle 10 or the bicycle 20 at precise and a priori determined locations or positions. By knowing the geometric relationship or geometry of those anchors or units 11, 12, 13, 14, 21, 22, for example, their relative coordinate transformations, not only the relative range to the other road user 10, 20, but also the direction can be determined without additional sensor or tag information. Further, it is possible that a Time Difference of Arrival (TDOA) (not shown), or the Angle of Arrival (AoA) (not shown) are used and evaluated for determining a position of the other road user. As a result, when using TDoA and/or AoA, not only a range, but a precise (absolute) position of the respective other road user 20, 10, relative to the ego road user 10, 20 can be determined.

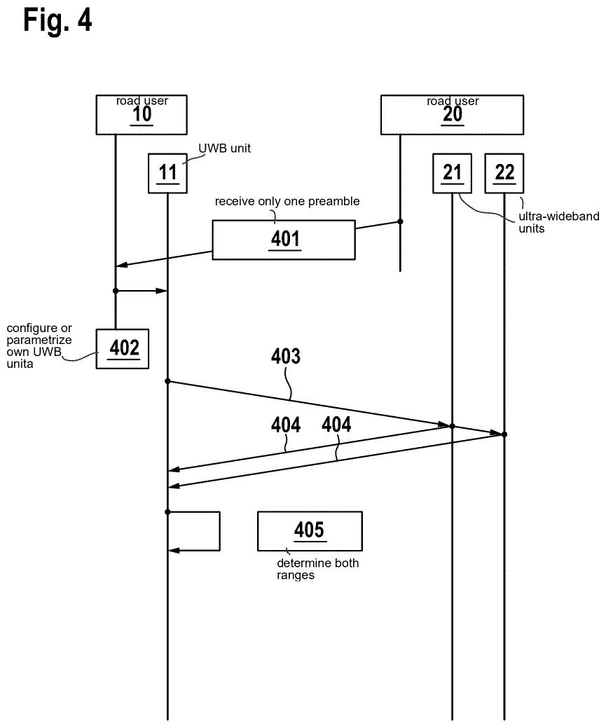

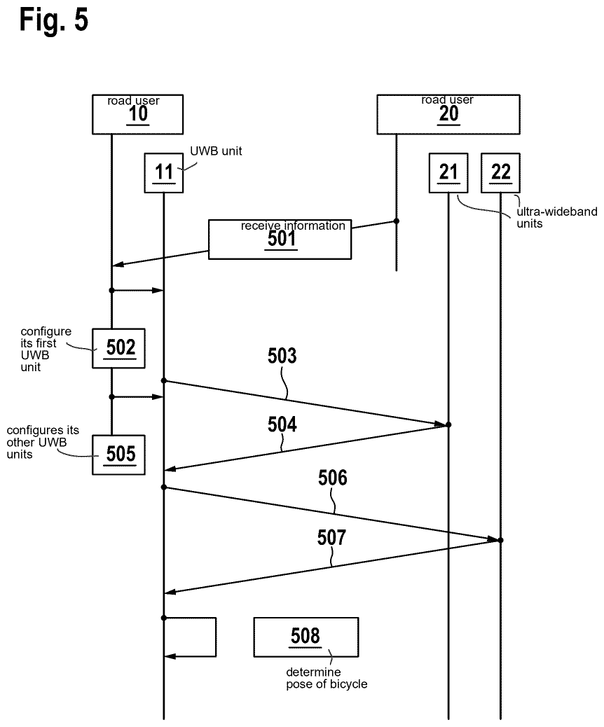

In FIG. 4 a schematic diagram of the method according to example embodiments of the present invention is illustrated. FIG. 4 shows a schematic process flowchart based on two road users 10, 20 with an exemplary vehicle 10 and a bicycle 20. In FIG. 4 and also in FIG. 5 the V2X technology can be used for receiving messages from the bicycle 20 as the other road user 20 to inform the vehicle 10 as the road user 10 for example about its UWB parameter set comprised in the preamble of the message. However, other technologies, for example Bluetooth Low Energy (BLE), may also be used for the initial coordination required before the actual ranging.

As depicted in FIG. 4 only one preamble is received in step 401 from the other road user 20 available for both UWB tags 21, 22 on the bicycle 20 bike. Therefore, at step 402 the vehicle 10 can use this preamble to configure or parametrize its own UWB tags 11, and 12, 13, 14 (not illustrated in FIG. 4) and start and perform the ranging between its first UWB tag 11 and UWB tags 21, 22 of the bicycle 20 in step 403. The ranging is replied by both tags 21, 22 from the bicycle 20 at step 404. The vehicle 10 can determine both ranges separately in its UWB unit 11 or UWB receiver 11. (Step 405).

Not shown in FIG. 4 are the further vehicle's UWB tags 12, 13, 14. Depending on the transceivers' respective capabilities, the same sequence as for the first UWB unit 11 will be performed sequentially afterwards or might also be performed simultaneously.

Optionally the vehicle 10 can also inform the bicycle 20 about the start of the ranging so that the antennas or UWB tags do not always have to stay in active mode for ranging responses but only when necessary.

FIG. 5 illustrates a further schematic process flowchart based on two road users 10, 20 with an exemplary vehicle 10 and a bicycle 20.

In contrast to FIG. 4 the bicycle 20 sends two different preambles for its UWB tags 21, 22. If the other road user 20 comprises more than two UWB tags it is possible that more than two different preambles are transmitted to the vehicle 10 or vice versa. This information is received by the vehicle 10 in step 501 like in step 401 of FIG. 4. However, in contrast to the embodiment in FIG. 4 the vehicle 10 may then start with for example preamble 1 and at step 503, 504 perform the ranging between the respective tags 11, 21 of the two road users 10, 20 after configuring 502 its first UWB tag 11. Afterwards the same steps may be performed in steps 505, 506, 507 using preamble 2 for the UWB tags 12 and 22 to determine a distance to the second UWB tag 22 of the bicycle 20. When all the ranging measurements are completed the vehicle 10 may determine in step 508 the pose of the bicycle 20 as the other road user 20.

In both procedures depicted in FIG. 4 and FIG. 5 as an option the above mentioned TDoA and AoA measurements may be used for the ranging information and determining the pose of the other road user 20.

Another embodiment the method of the present invention can also be performed the other way round such that each of the two road users 10, 20 can know each other's position after determining the respective pose.

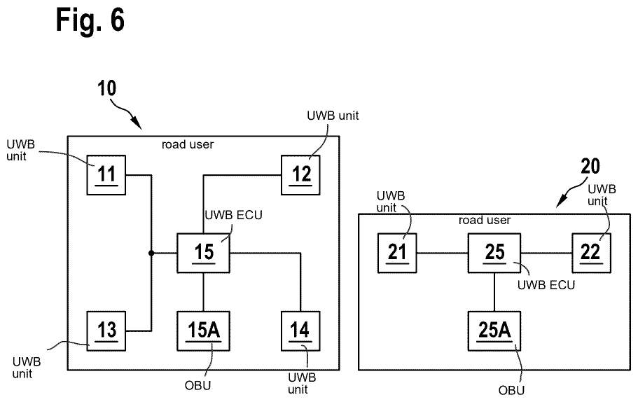

FIG. 6 illustrates in particular an exemplary architecture or a technical setup of a hardware module comprising multiple ultra-wideband units or UWB tags for the vehicle 10 and the bicycle 20. For both of them each UWB tag 11, 12, 13, 14, 21, 22 may be connected to a UWB electronic control unit (ECU) 15, 25. In this embodiment shown in FIG. 6 for UWB tags 11, 12, 13, 14 are shown for the vehicle 10 and two UWB tags 21, 22 for the bicycle 20 or vulnerable road user 20. Other embodiments or combinations are possible. The UWB ECU 15, 25 is further connected to a connectivity control unit (CCU) or On-Board Unit (OBU) 15A, 25A, which can provide wireless communication technologies such as for example via direct V2X communication (e.g. DSRC/C-V2X) or via a cellular communication (e.g. 5G/6G) or via Bluetooth.

The above explanation of the embodiments describes the present invention in the context of examples. Of course, individual features of the embodiments can be freely combined with each other, provided that this is technically reasonable, without leaving the scope of the present invention.

What is claimed is:

1. A method for determining a pose of another road user, the method comprising the following steps performed by a computer of a road user using a multi antenna ultra-wideband system:
receiving information including an indication regarding a capability for ultra-wideband-based ranging of the other road user, at least one set of parameters for two or more ultra-wideband units of the road user to configure each of the two or more ultra-wideband unit of the road user, and an information with respect to a geometric relationship of two or more ultra-wideband units of the other road user;
configuring the two or more ultra-wideband units of the road user based on the at least one set of parameters to enable respective ultra-wideband ranging measurements;
performing the respective ultra-wideband ranging measurements between the two or more ultra-wideband units of the road user and the two or more ultra-wideband units of the other road user;
determining a pose of the other road user based on each or a subset of the performed ultra-wideband ranging measurements and based on the geometric relationship of the two or more ultra-wideband units of the other road user, wherein the pose includes a position information of the other road user and/or an orientation information of the other road user.

2. The method of claim 1, wherein the information includes a different set of parameters for each of the ultra-wideband units of the road user, or one single set of parameters for all ultra-wideband units of the road user, to configure each of the ultra-wideband units of the road user.

3. The method of claim 2, wherein the information is received via a message from the other road user, wherein: (i) the message includes one preamble in case of the single set of parameters, or (ii) the message includes at least two preambles in case of different sets of parameters.

4. The method of claim 3, wherein the message is a V2X-message or a cooperative awareness message or a vehicle awareness message.

5. The method of claim 1, wherein the geometric relationship is specified by a respective position of the two or more ultra-wideband units of the other road user in relation to each other or to a common reference point.

6. The method of claim 1, wherein, during the performing of the respective ultra-wideband ranging measurements, the following step is performed:
initiating the respective ranging measurements between two or more ultra-wideband units of the road user and/or the two or more ultra-wideband units of the other road user using a Time Difference of Arrival (TDoA) measurement and/or Angle of Arrival (AoA) measurement, wherein the ranging measurements are used to determine a relative distance and direction between the road user and the other road user.

7. The method of claim 1, wherein the method further comprises the further following step:
mapping a result of the respective ranging measurements from each or the subset of the two or more ultra-wideband units of the road user to a local coordinate system of the road user, allowing for a determination of an absolute position of the other road user.

8. The method of claim 1, wherein each or the subset of the respective ultra-wideband ranging measurements between the two or more ultra-wideband units of the road user and/or the two or more ultra-wideband units of the other road user is performed sequentially or in parallel.

9. The method of claim 1, wherein the steps of the method are performed iteratively in a tracking process between the road user and the other road user to refine the determination of the pose.

10. The method of claim 1, wherein the method further comprises the following step:
providing information regarding a relative position of the other road user to one or more driver assistance systems of the road user to enable improved safety features.

11. A non-transitory computer-readable storage medium on which are stored instructions for determining a pose of another road user, the instructions, when executed by a computer of a road user using a multi antenna ultra-wideband system, causing the computer to perform the following steps:
receiving information including an indication regarding a capability for ultra-wideband-based ranging of the other road user, at least one set of parameters for two or more ultra-wideband units of the road user to configure each of the two or more ultra-wideband unit of the road user, and an information with respect to a geometric relationship of two or more ultra-wideband units of the other road user;
configuring the two or more ultra-wideband units of the road user based on the at least one set of parameters to enable respective ultra-wideband ranging measurements;
performing the respective ultra-wideband ranging measurements between the two or more ultra-wideband units of the road user and the two or more ultra-wideband units of the other road user;
determining a pose of the other road user based on each or a subset of the performed ultra-wideband ranging measurements and based on the geometric relationship of the two or more ultra-wideband units of the other road user, wherein the pose includes a position information of the other road user and/or an orientation information of the other road user.
